(19) United States
(12) Patent Application Publication
(10) Pub. No.: US 2008/0216290 A1
(43) Pub. Date: Sep. 11, 2008

(54) HINGE ASSEMBLY

(75) Inventors: Nicholas K. Kroes, Muskegon, MI (US); Kevin E. Hannula, Cadillac, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: SAFETY HINGE, LLC, Muskegon, MI (US)

(21) Appl. No.: 12/044,277

(22) Filed: Mar. 7, 2008

Related U.S. Application Data
(60) Provisional application No. 60/893,465, filed on Mar. 7, 2007.

(51) Int. Cl. E05D 5/00

(52) U.S. Cl. 16/382

(57) ABSTRACT

A hinge assembly includes a hinge bracket attached to a mounting surface and an insert bracket nested within the hinge bracket. The insert bracket includes a standoff support surface proximate the first end and a retention clip proximate the second end. The hinged object is hingedly attached to at least one of the insert bracket and the hinge bracket and is moveable between a first position in which it engages the standoff support surface and a second position in which it engages the retention clip. The hinge bracket may include a pair of walls extending from opposite sides of the hinge bracket that include rounded corners to move the user's fingers away from the hinge area and the first support surface.

### BACKGROUND OF THE INVENTION

The present invention relates to a hinge assembly, and more particularly to a hinge assembly that provides a standoff and retention mechanism for a hinged object such as a boat ladder.

Hinged objects, such as boat swim ladders, are convenient in that they can be easily moved between a first position in which the ladder extends downwardly toward the water—and in some cases into the water—and can be used to climb on or off of the boat, and a second position in which the ladder is pivoted upwardly such that it does not drag behind the boat when the boat is moving. A typical boat ladder design includes a pair of U-shaped metal brackets that are fastened to the transom, and a ladder formed from round tubing that is hingedly secured to the brackets by fasteners that extend through the walls of the brackets and the ladder tubing.

Unfortunately, the typical boat ladder design suffers from a number of drawbacks. One significant drawback is the pinch points that are formed between the ladder and the boat transom, and between the ladder and the brackets. Users are susceptible to getting their fingers caught in these pinch points when moving the ladder between the raised and lowered positions, and also when grabbing onto portions of the ladder during normal use of the ladder. In addition, the process of retaining the ladder in the raised position—which usually involves a separate latch attached to the boat transom—can be cumbersome for users and time consuming for manufacturers.

### SUMMARY OF THE INVENTION

The present invention provides a hinge assembly that helps prevent pinched fingers when deploying and using the hinged object.

In one embodiment, the hinge assembly includes a hinge bracket attached to the mounting surface and an insert bracket nested within the hinge bracket. The insert bracket includes a first end and a second end, a first support surface proximate the first end and spaced from the mounting surface and a second support surface proximate the second end and spaced from the mounting surface. The hinged object is hingedly attached to at least one of the insert bracket and the hinge bracket and is moveable between a first position in which it engages the first support surface of the insert bracket and a second position in which it engages the second support surface of the insert bracket. The first support surface offsets the hinged object from the mounting surface to reduce, and in some cases eliminate, the pinch point between the hinged object and the mounting surface.

In another embodiment, the hinge bracket includes a pair of walls extending from opposite sides of the hinge bracket, and the insert bracket is nested between the walls of the hinge bracket. The walls of the hinge bracket may extend outwardly beyond the insert bracket, and may include rounded corners at the ends of the hinge bracket. The walls, and their rounded corners, tend to move the user's fingers away from the hinge area and the first support surface.

In another embodiment, the second support surface of the insert bracket includes a retention clip that is shaped to receive the hinged object and to retain the hinged object in the second position. The tension of this clip may be user-adjustable to help assure that the object retained is held as tightly as necessary for the application. The retention clip thus eliminates the need for a separate latch mounted to the transom for holding the ladder in the raised position.

These and other objects, advantages, and features of the invention will be readily understood and appreciated by reference to the detailed description of the current embodiment and the drawings.

### BRIEF DESCRIPTION OF THE DRAWINGS

FIG. 1 is a perspective view of the hinge assembly according to one embodiment of the present invention with the hinged object in a first position.

FIG. 2 is a close-up view of a hinged object in the first position.

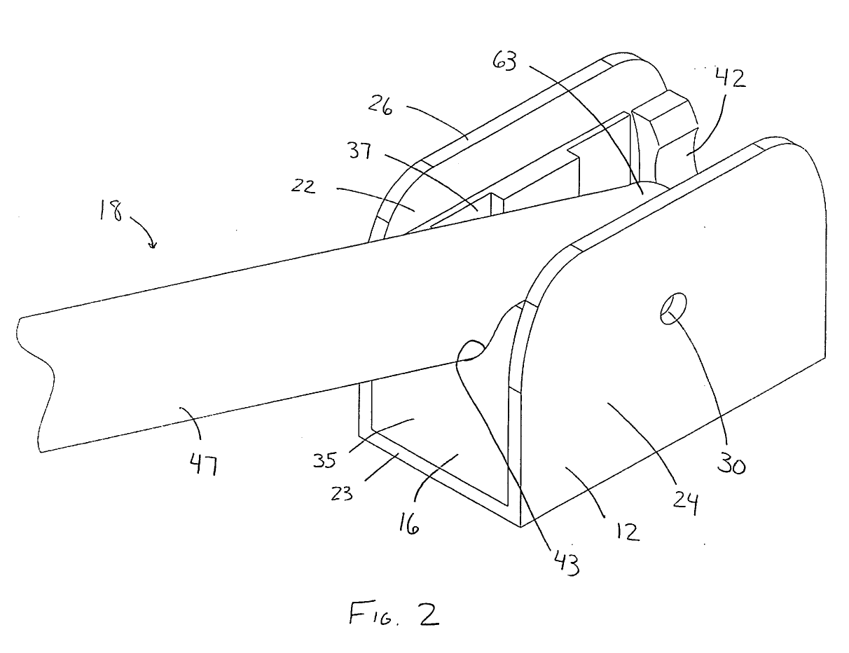

FIG. 3 is a perspective view of the hinge assembly with the hinged object in a second position.

FIG. 4 is a close-up view of a hinged object in the second position.

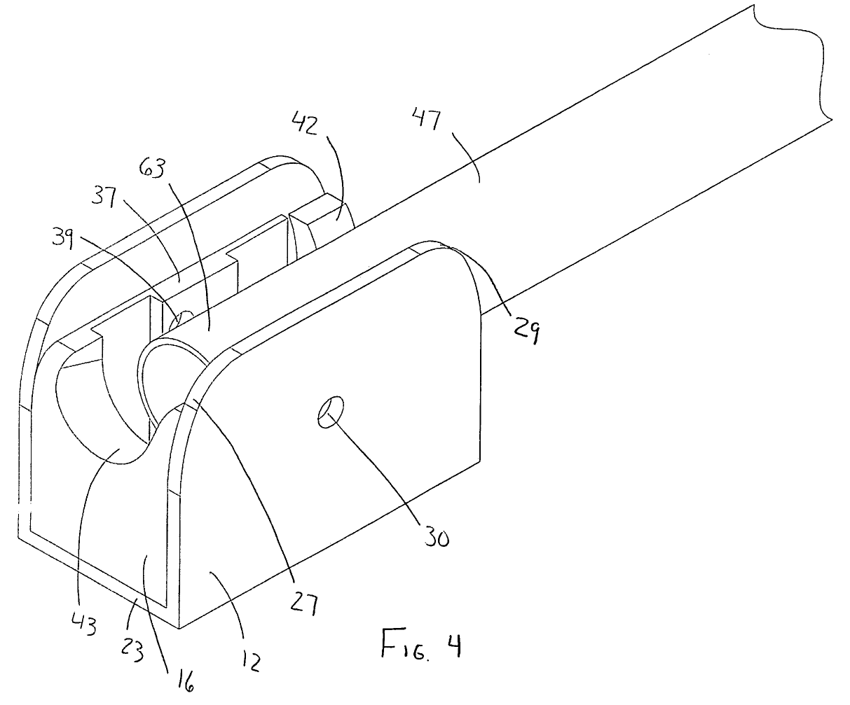

FIG. 5 is a perspective view of one embodiment of the hinge bracket.

FIG. 6 is a perspective view of one embodiment of the insert bracket.

FIG. 7 is an exploded view of the hinge assembly.

FIG. 8 is a perspective view of the hinge assembly attached to a boat transom.

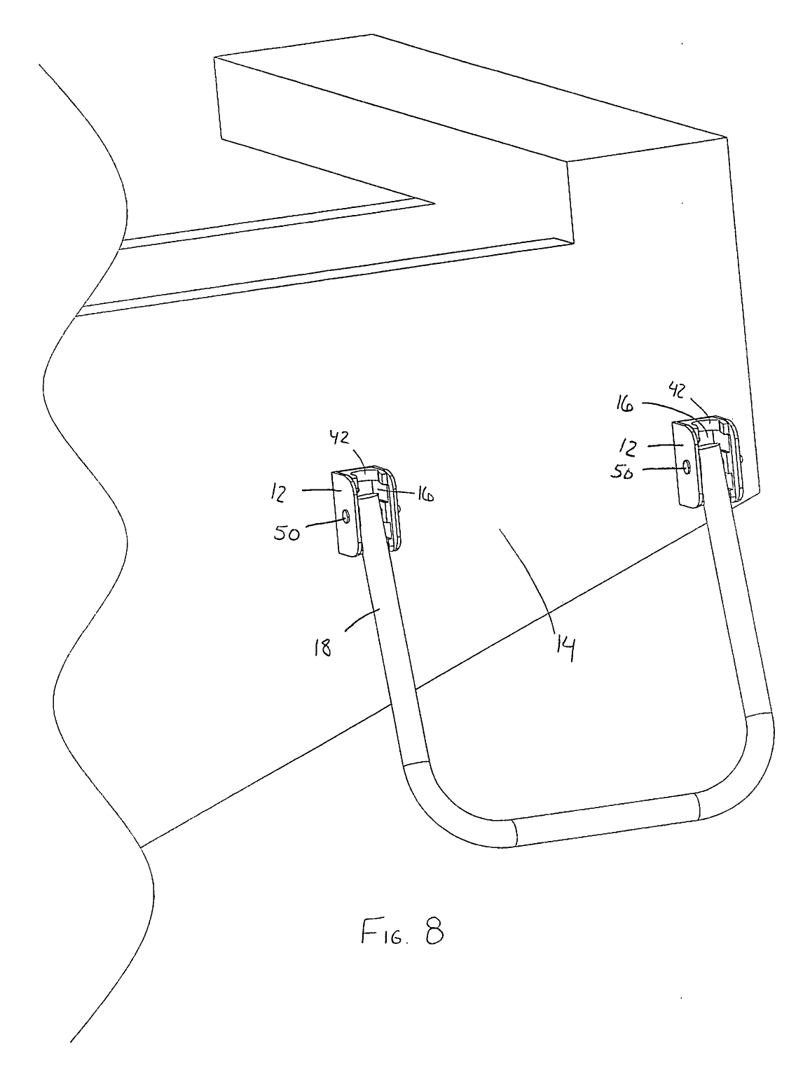

### DETAILED DESCRIPTION OF THE CURRENT EMBODIMENT

I. Overview

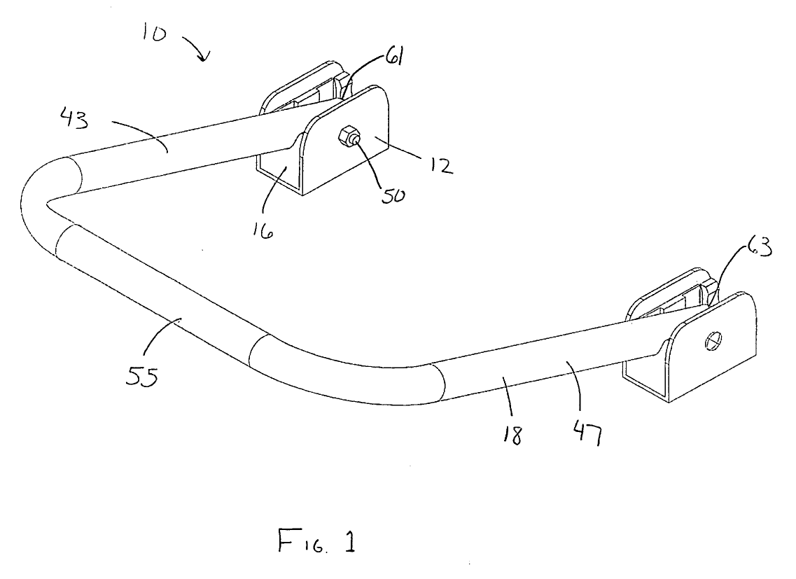

A hinge assembly according to one embodiment of the present invention is shown in FIG. 1 and generally designated 10. In one embodiment, the hinge assembly 10 attaches an object to a mounting surface. In the illustrated embodiment, the hinge assembly 10 is designed for attaching a ladder 18 to a mounting surface, such as a boat transom. However, the hinge may be used to attach a variety of objects, including, but not limited to: a post, a ladder, a flag pole, an antenna, a tube, a bimini-top upright and an awning brace, to a variety of mounting surfaces, including, but not limited to: a wall, a boat transom, a table leg, a fence post, a pontoon rub rail, a table top, a windowsill and a desktop. In one embodiment, the hinge assembly 10 includes a hinge bracket 12 attached to the mounting surface 14, an insert 16 and a hinged object 18 hingedly attached to the insert 16 and bracket 12.

II. Structure

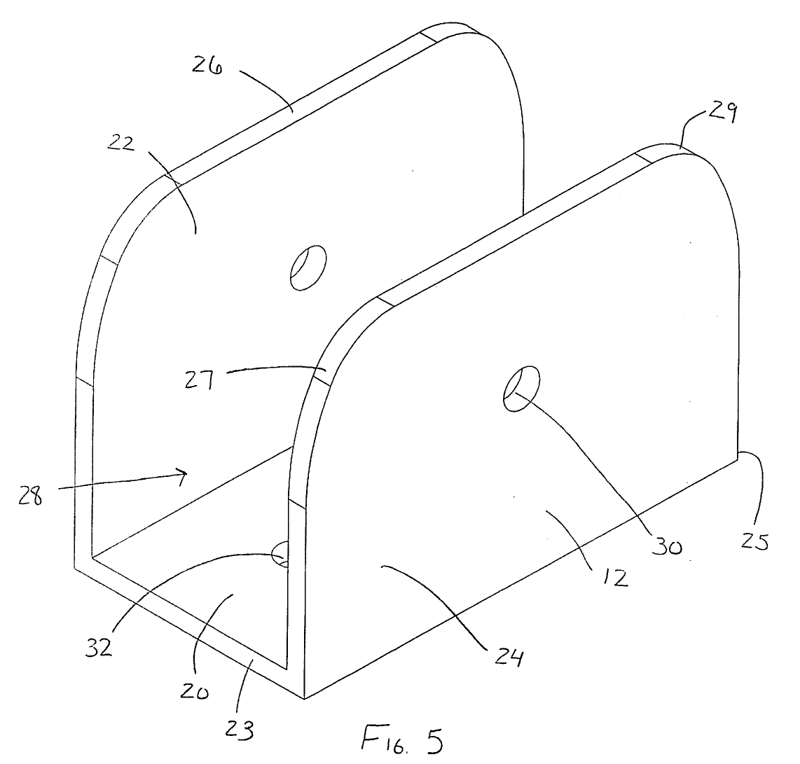

In one embodiment, the hinge bracket 12 provides both the pivot point for the object 18 to be hinged as well as the attachment of the hinge assembly 10 to the mounting surface. Referring to FIG. 5, the hinge bracket 12 may include a generally flat base plate 20 having a first end 23 and a second end 25 opposite the first end 23 and identical to the first end. A pair of walls 22, 24 extend outwardly from the plate 20. In the illustrated embodiment, the walls 22, 24 are generally perpendicular to the base plate 20. In one embodiment, the walls 22, 24 include an outer edge 26 with at least one rounded or curved surface to help push a user's fingers away from the outer edge and potential pinch points. As illustrated, the outer edge 26 of each wall 22, 24 includes radiused corners 27, 29 at the first 23 and second 25 ends of the hinge bracket 12 respectively. In an alternative embodiment, the outer edge 26 of the walls 22, 24 may have radiused corners at only one end, or the outer edges 26 may curve continuously from one end to the other, for instance, in a semi-circular shape or another curved shape.

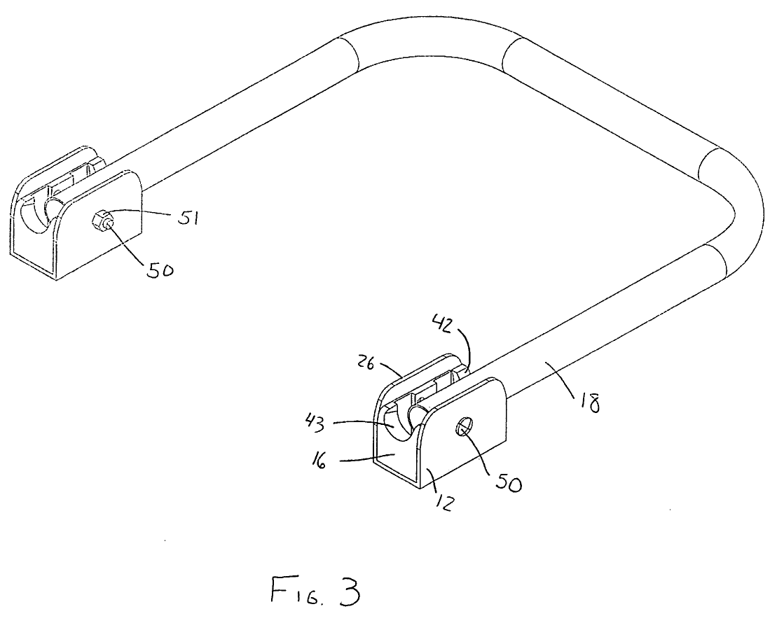

The hinge bracket 12 defines a space 28 between the walls 22, 24 that provides a location into which can be nested the insert 16 as described below. In one embodiment, the walls 22, 24 each include a hole 30 for receiving a fastener 50 for hingedly attaching the hinged object 18, such that the hinged object 18 is movable between a first position, or “in-use” position, shown in FIG. 1 and a second position shown in FIG. 3. In the illustrated embodiment, the fastener 50 is a bolt that is held in place with a nut 51. The base plate 20 may include holes 32 for receiving fasteners to attach the assembly 10 to a mounting surface. In one embodiment, the bracket 12 may also include holes (not shown) in the walls 22, 24 into which set screws (not shown) may be inserted for adjusting the tension of the insert's retention clip (described below).

The hinge bracket 12 could be produced in many different sizes without adversely affecting its functionality. The hinge bracket 12 may be made from a variety of materials, and is typically made from metal, such as aluminum or steel. In one embodiment, the entire hinge bracket is formed from a single, unitary piece.

As noted above, in the illustrated embodiment, the hinged object 18 is a ladder. In particular, the hinged object 18 shown is a one-step ladder 18 having a first support member 43 and a second support member 47 joined by a cross member 55. As shown, the ladder is constructed out of 1″ aluminum tubing, however, a variety of shapes and materials may be used. Ladders or objects of smaller or larger dimensions could be accommodated by correspondingly larger or smaller hinges. The support members 43, 47 each have holes 57, 59 within end portions 61, 63 that receive the fasteners 50 so the ladder 18 can pivot about the fastener 50 between the first position and the second position.

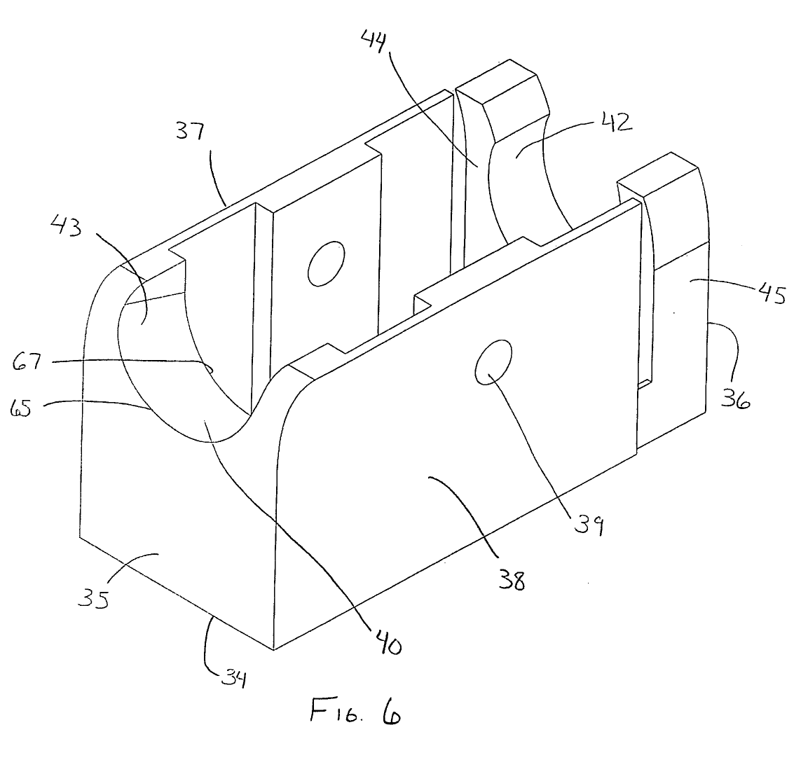

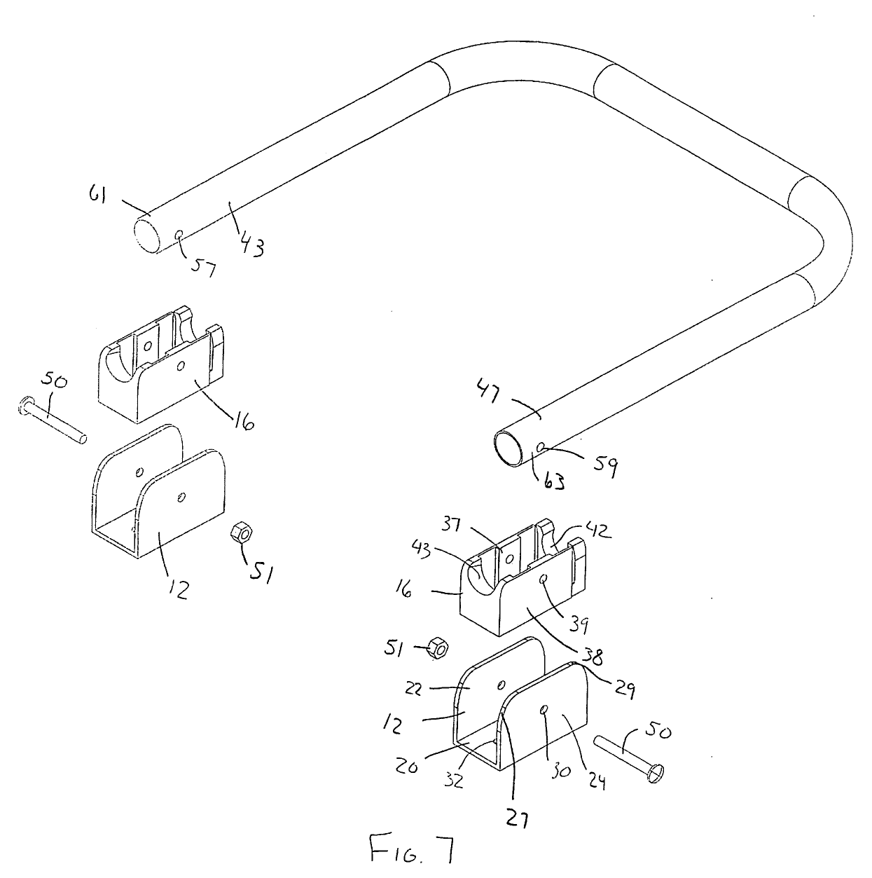

Referring now to FIGS. 6-7, in one embodiment, the insert 16 is designed to nest inside the hinge bracket 12. The size of the insert 16 may vary depending on the size of the hinge bracket 12 that is deemed optimum for a given application. The insert 16 may be made from a variety of materials, including metal or plastic. In an alternative embodiment, the insert 16 may be formed integrally with the hinge bracket 12 as a unitary piece.

The insert 16 may include a lower surface 34, a first end 35, a second end 36, and a pair of walls 37, 38 extending upwardly from the lower surface 34. The lower surface 34 may be a generally flat wall of approximately the same thickness as the walls 37, 38. As shown, the insert 16 includes a standoff support surface 40 at the first end 35 and a retention clip 42 at the second end 36. In one embodiment, the standoff 40 extends upwardly from the lower surface 34, and includes a wall with an upper end that forms a radiused bed 43 that is shaped to cradle the hinged object 18 when the object is in its “in use” position. The standoff 40 functions to offset the hinged object 18 away from the mounting surface 14. In the illustrated embodiment, the radiused bed 43 is also angled such that the outer edge 65 of the radiused bed 43 is higher than the inner edge 67. The angled radiused bed 43 supports the hinged object 18 such that it angles away from the mounting surface. The angle of this radiused bed, and the height of the offset, could be increased or decreased according to the application demands. The shape of the radiused bed 43 could be varied to accommodate any size or shape of hinged object. This radiused bed 43 decreases deflection of the surface of the hinged object 18 by spreading the pressure of the offset onto a larger area.

In one embodiment, the insert bracket 16 also includes a retention clip 42 positioned at the second end 36 of the insert 16 opposite the standoff 40. The retention clip 42 serves to firmly hold the hinged object 18 when it is pivoted to the second position, and not resting on the standoff bed 43. In the illustrated embodiment, the clip would snap the boat ladder 18 into the second, or “up,” position when not deployed into the water. As shown in FIG. 6, the retention clip 42 may include a pair of fingers 44, 45 that extend from the insert 16 and curve inwardly to frictionally engage the hinged object 18 when the object is moved to the second position. In one embodiment, the retention clip 42 includes a generally flat wall at the second end 36 of the insert, with generally symmetrical fingers 44, 45 extending upwardly therefrom. The fingers 44, 45 may have a degree of flexibility to allow the hinged object to “snap” into the retention clip 42. As illustrated, the retention clip 42 and fingers 44, 45 are spaced from the walls 37, 38 to provide a degree of flexibility. As shown, the insert 16 is narrower at the retention clip 42 than at the standoff 40. This allows flexibility in the retention clip 42 when a hinged object 18 is “snapped” into place. User-adjustability of the clip tension may be provided through the use of one or more set screws (not shown) mounted into the hinge bracket 12. These screws may be tightened or loosened to press on the fingers and tighten the retention clip 42 according to the amount of grip required by a given application.

The insert 16 may include a hole 39 in each wall 37, 38. In the illustrated embodiment, the holes 39 align with the holes 30 in the hinge bracket 12 to receive the fasteners 50 that extend through the hinge bracket 12, the insert 16 and the hinged object 18. The insert 16 may also define holes (not shown) in the lower surface 34 to receive any fasteners that extend through the holes 32 in the hinge bracket 12. In an alternative embodiment, the lower surface 34 of the insert bracket 16 may include a cutout that is large enough to accommodate any such fasteners. In yet another embodiment (not shown), the holes in the lower surface of the insert bracket may be used to attach the insert 16 to the hinge bracket 12.

In an alternative embodiment, the hinge bracket and insert bracket might be adapted to other applications by offering either two standoffs and no retention clip or, alternatively, two retention clips and no standoff. In another embodiment, both of these functions may be combined into standoffs with integral retention. As with the hinge bracket 12, the insert 16 could be produced in many different sizes without adversely affecting its functionality.

III. Assembly

In one embodiment, a pair of the insert brackets 16 are nested inside a pair of the hinge brackets 12 and mounted to the mounting surface 14 such that they are spaced apart and held in place by the same fasteners that extend through the holes 32 in the base plate 20 of the hinge bracket 12 to secure the hinge bracket 12 and insert bracket 16 to the mounting surface 14. An alternative would be to hold the hinge brackets 12 and insert brackets 16 in place with the fasteners 50 that are used to hold the hinged object 18. The hinged object 18 is attached by positioning the support members 43, 47 in the nested brackets and extending the fasteners 50 through the holes 30 in the hinge brackets 12, the holes 39 in the insert brackets 16 and through the holes 57, 59 in the support members 43, 47. The fasteners 50 are held in place with the nuts 51 attached to one end of each fastener. The fasteners attach such that the hinged object 18 can be moved between a the first, “use” position, wherein the hinged object 18 rests on the standoff, and a second “retained” position, wherein the hinged object 18 is snap fitted or otherwise held in the retention clip 42.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property of privilege is claimed are defined as follows:

1. A hinge assembly comprising:
a mounting surface;
a hinge bracket attached to said mounting surface;
an insert bracket nested within said hinge bracket, said insert bracket including a first end and a second end, a first support surface proximate said first end and spaced from said mounting surface and a second support surface proximate said second end and spaced from said mounting surface; and
a hinged object hingedly attached to at least one of said insert bracket and said hinge bracket, said hinged object moveable between a first position in which said hinged object engages said first support surface of said insert bracket and a second position in which said hinged object engages said second support surface of said insert bracket.

2. The hinge assembly of claim 1 wherein said hinge bracket includes a base, and a pair of walls extending upwardly from said base, said insert bracket nested between said walls, said walls each having an upper edge, a first end, a second end, and a radiused corner at said first end.

3. The hinge assembly of claim 2 wherein said first support surface of said insert bracket includes a radiused bed that receives said hinged object in said first position.

4. The hinge assembly of claim 3 wherein said second support surface of said insert bracket includes a retention clip, said retention clip receiving said hinged object and retaining said hinged objected in said second position.

5. The hinge assembly of claim 4 wherein said retention clip is shaped to correspond to the shape of said hinged objection, such that said retention clip is capable if frictionally retaining said hinged object in said second position.

6. The hinge assembly of claim 5 wherein said insert bracket includes a base and a pair of walls extending upwardly from said base generally between said first end and said second end, said radiused bed extending between said walls at said first end and said retention clip extending between said walls at said second end.

7. The hinge assembly of claim 6 wherein said hinged object is a ladder.

8. The hinge assembly of claim 7 wherein said walls of said hinge bracket define a first set of mounting holes, and wherein said walls of said insert bracket define a second set of mounting holes aligned with said first set of mounting holes, and wherein a fastener extends through said first set of mounting holes, said second set of mounting holes and said ladder to hingedly mount said ladder.

9. A hinge assembly for attaching an object to a mounting surface, comprising:
a hinge bracket including a base portion and an attachment portion, said base portion secured to the mounting surface, said attachment portion hingedly attached to the object such that the object can pivot between a first position and a second position; and
an insert bracket, said insert bracket including a standoff support surface spaced from the mounting surface, said object engaging said standoff support surface in said first position.

10. The hinge assembly of claim 9 wherein said attachment portion of said hinge bracket envelops a portion of said insert bracket.

11. The hinge assembly of claim 10 wherein said attachment portion of said hinge bracket includes first and second walls extending upwardly from said base portion, said first and second walls each including a curved outer edge that extends beyond said insert bracket.

12. The hinge assembly of claim 11 wherein said insert bracket includes a retention clip, said object capable of snap-fitting into said retention clip in said second position.

13. The hinge assembly of claim 12 wherein said insert bracket includes a base having a first end and a second end, said support surface extending upwardly from said first end, said retention clip extending upwardly from said second end.

14. The hinge assembly of claim 13 wherein said insert bracket includes a first wall and a second wall, said first and second walls extending substantially between said first and second ends of said insert bracket.

15. The hinge assembly of claim 14 wherein said first wall of said hinge bracket is positioned adjacent said first wall of said insert bracket and wherein said second wall of said hinge bracket is positioned adjacent said second wall of said insert bracket.

16. The hinge assembly of claim 15 wherein said first and second walls of said hinge bracket define a first set of mounting holes, and wherein said first and second walls of said insert bracket define a second set of mounting holes aligned with said first set of mounting holes, and wherein a fastener extends through said first set of mounting holes, said second set of mounting holes and the object to hingedly mount said object.

17. A hinge assembly for supporting a hinged object comprising:
a mounting surface;
a hinge bracket secured to said mounting surface and supporting the hinged object, said hinge bracket including a base having first and second ends and first and second sides, said hinge bracket including first and second walls extending upwardly from said first and second sides respectively, said first and second walls extending perpendicular to said base, said first and second walls each having an attachment portion and an outer edge, said outer edge having rounded corners proximate said first and second ends, said attachment portion positioned between said first and second ends of said base and capable of hingedly supporting said hinged object such that said hinged object is movable between a first position and a second position; and
an insert bracket secured to said hinge bracket and nested between said first and second walls of said hinge bracket, said insert bracket including a base having a first end and a second end, a standoff extending upwardly from said first end, and a retention clip extending upwardly from said second end, said standoff spaced from said mounting surface to support said hinged object in said first position, said retention clip shaped to retain said hinged object in said second position.

18. The hinge assembly of claim 17 including two of said hinge brackets and said insert brackets, wherein said hinged object is a ladder having a pair of tubes connected by a cross member, one of said tubes attached to said attachment portion of one of said hinge brackets and the other of said tubes attached to said attachment portion of the other of said hinge brackets.

19. The hinge assembly of claim 18 wherein said tubes have a round cross section, and wherein said retainer clip is shaped to correspond to said round cross section.

20. The hinge assembly of claim 19 wherein said hinge brackets are substantially metal and said insert brackets are substantially plastic.
